(19) United States
(12) Patent Application Publication
(10) Pub. No.: US 2024/0281333 A1
(43) Pub. Date: Aug. 22, 2024

(54) METHOD AND APPARATUS FOR RECOVERING DELETED DATA ON LOW FLASH MEMORY FORMATTED WITH UBIFS

(71) Applicant: Korea University Research and Business Foundation, Seoul (KR)

(72) Inventors: Jungheum PARK, Seoul (KR); Junho KIM, Seongnamsi (KR); Youngki JUNG, Seoul (KR); Woo Sung YUN, Seoul (KR); Sang Jin LEE, Seoul (KR)

(21) Appl. No.: 18/583,253

(22) Filed: Feb. 21, 2024

(30) Foreign Application Priority Data
Feb. 21, 2023 (KR) 10-2023-0023018
Apr. 10, 2023 (KR) 10-2023-0046530

(51) Int. Cl. G06F 11/14; G06F 16/14; G06F 16/18

(52) U.S. Cl. CPC G06F 11/1435; G06F 16/148; G06F 16/1847

(57) ABSTRACT

A method of recovering deleted data on a low flash memory formatted in UBIFS according to an embodiment of the present invention includes: (a) a first step of receiving a UBI volume configured by collecting memory data from the low flash memory; and (b) a second step of determining a node type by searching for a node header in all areas of the input UBI volume, and recovering deleted data through a structural analysis performed on each determined node type, wherein the determined node type is either a directory node or a data node, which are leaf nodes according to a B+ tree structure.

### CROSS-REFERENCE TO RELATED PATENT APPLICATION

This application claims the benefit of Korean Patent Application No. 10-2023-0023018, filed on Feb. 21, 2023, and Korean Patent Application No. 10-2023-0046530, filed on Apr. 10, 2023, in the Korean Intellectual Property Office, the disclosure of which is incorporated herein by reference in their entireties.

### TECHNICAL FIELD

The present invention relates to a method of recovering deleted data on a low flash memory formatted in UBIFS, and an apparatus for the same, more specifically, to a method of recovering deleted data remaining in an unallocated area by analyzing the UBIFS formatted on a low flash memory, and an apparatus for the same.

### BACKGROUND ART

As a flash memory is a memory that can maintain data even when power is cut off and may operate with low power, it is widely used in embedded systems such as refrigerators, washing machines, CCTVs, and the like where it is difficult to embed large memories.

Meanwhile, Unsorted Block Image File System (UBIFS) is a representative file system of the flash memory and is used in many embedded systems, and although demands for digital forensic analysis of the UBIFS are also increasing as the use of the UBIFS increases recently, methods of recovering deleted data existing in an unallocated area have not been developed yet while methods of acquiring normal data stored in the UBIFS are well known.

### PATENT DOCUMENTS

Korean Patent Registration No. 10-2400723 (2022 May 18)

### DISCLOSURE OF INVENTION

### Technical Problem

Therefore, the present invention has been made in view of the above problems, and it is an object of the present invention to provide a method of recovering deleted data on a low flash memory formatted in UBIFS, and an apparatus for the same, which can recover deleted data existing in an unallocated area in accordance with increase in demands for digital forensic analysis of the UBIFS, and an apparatus for the same.

The technical problems of the present invention are not limited to the technical problems mentioned above, and unmentioned other technical problems will be clearly understood by those skilled in the art from the following description.

### Technical Solution

To accomplish the above object, according to an embodiment of the present invention, there is provided a method of recovering deleted data on a low flash memory formatted in Unsorted Block Image File System (UBIFS), the method comprising: (a) a first step of receiving a UBI volume configured by collecting memory data from the low flash memory; and (b) a second step of determining a node type by searching for a node header in all areas of the input UBI volume, and recovering deleted data through a structural analysis performed on each determined node type, wherein the determined node type is either a directory node or a data node, which are leaf nodes according to a B+ tree structure.

According to an embodiment, the first step may include any one or more among: step 1-1 of determining whether the low flash memory exists in the apparatus; step 1-2 of collecting, when a low flash memory exists as a result of the determination, memory data from the low flash memory; step 1-3 of removing a spare area in the collected memory data; step 1-4 of identifying a file system area by analyzing partition information of the memory data from which the spare area is removed; step 1-5 of configuring the UBI volume by grasping a physical structure of the identified file system area; and step 1-6 of receiving the configured UBI volume.

According to an embodiment, collection of memory data at step 1-2 may be collection of memory data from the low flash memory through a Universal Asynchronous Receiver Transmitter (UART) communication method.

Step 1-5 may include any one or more among: step 1-5-1 of identifying one or more Physical Erase Blocks (PEBs) on a Memory Technology Device (MTD) area from the physical structure of the identified file system area; step 1-5-2 of moving as much as an offset of a Version Identifier (VID) header in an EC header included in each of the one or more identified PEBs; step 1-5-3 of determining, when a VID header exists as a result of the moving, a Logical Erase Block (LEB) number recorded in the VID header, and mapping the LEB number to the PEB; and step 1-5-4 of configuring the UBI volume by arranging LEBs mapped to the PEBs.

According to an embodiment, the second step may include any one or more among: step 2-1 of searching for a node header in all areas of the input UBI volume; step 2-2 of determining a node type through a structural analysis of the searched node header, and acquiring a file name and actual data of the deleted data; step 2-3 of determining whether all node headers are searched in all areas of the input UBI volume; and step 2-4 of analyzing a relationship between nodes of the deleted data and recovering the deleted data when all node headers are searched as a result of the determination.

According to an embodiment, searching for a node header at step 2-1 may be searching for 0x31181006 (1500), which is a unique value of the node header, in all areas of the UBI volume.

According to an embodiment, when the node type determined at step 2-2 is a directory node, step 2-2 may include any one or more among: step 2-2-1 of determining whether an Inum value in the directory node is 0; step 2-2-2 of determining the node type, when the Inum value is 0 as a result of the determination, as the directory node of the deleted data, and acquiring a file name of the deleted data from the directory node; and step 2-2-3 of inferring an Inum value of the directory node before the data is deleted through a node key value of an i-node of the same data connected immediately after the directory node of the deleted data.

According to an embodiment, when the node type determined at step 2-2 is a data node, step 2-2 may include any one or more among: step 2-2-1′ of identifying a node key value of the data node; step 2-2-2′ of identifying a length of the deleted data stored in the data node; and step 2-2-3′ of acquiring deleted actual data by extracting data as much as the identified length of data from a starting point of the data.

According to an embodiment, analyzing a relationship between nodes of the deleted data at step 2-4 may be analyzing a directory node of the deleted data and a data node having a node key value the same as the Inum value, which is inferred through the node key value of the i-node of the same data connected to the directory node of the deleted data, as a directory node and a data node of the same data.

To accomplish the above object, according to another embodiment of the present invention, there is provided an apparatus for recovering deleted data on a low flash memory formatted in UBIFS, the apparatus comprising: one or more processors; a network interface; a memory for loading a computer program executed by the processors; and a storage for storing large-capacity network data and the computer programs, wherein the computer program executes (A) a first operation of receiving a UBI volume configured by collecting memory data from the low flash memory; and (B) a second operation of determining a node type by searching for a node header in all areas of the input UBI volume, and recovering deleted data through a structural analysis performed on each determined node type, by the one or more processors, wherein the determined node type is either a directory node or a data node, which are leaf nodes according to a B+ tree structure.

To accomplish the above object, according to still another embodiment of the present invention, there is provided a computer program stored in a computer-readable medium, the program comprising: (AA) a first step of receiving a UBI volume configured by collecting memory data from a low flash memory; and (BB) a second step of determining a node type by searching for a node header in all areas of the input UBI volume, and recovering deleted data through a structural analysis performed on each determined node type, in combination with a computing device, wherein the determined node type is either a directory node or a data node, which are leaf nodes according to a B+ tree structure.

### Advantageous Effects

According to the present invention as described above, as deleted data existing in an unallocated area of UBIFS can be recovered using the B+ tree structure and the characteristics of nodes, there is an effect in that digital forensic analysis of the UBIFS can be performed more easily.

The effects of the present invention are not limited to the effects mentioned above, and unmentioned other effects will be clearly understood by those skilled in the art from the description of the claims.

### BRIEF DESCRIPTION OF THE DRAWINGS

FIG. 1 is a view exemplarily showing the overall configuration of an apparatus for recovering deleted data on a low flash memory formatted in UBIFS according to a first embodiment of the present invention.

FIG. 2 is a flowchart illustrating representative steps of a method of recovering deleted data on a low flash memory formatted in UBIFS according to a second embodiment of the present invention.

FIG. 3 is a flowchart specifying step S210, which is a first step of configuring and receiving a UBI volume, in a method of recovering deleted data on a low flash memory formatted in UBIFS according to a second embodiment of the present invention.

FIG. 4 is a view exemplarily showing a memory area including a file system area, from which spare areas are removed.

FIG. 5 is a view exemplarily showing a mimetic diagram configuring a UBI volume.

FIG. 6 is a flowchart specifying step S210-1-5 of configuring a UBI volume, in a method of recovering deleted data on a low flash memory formatted in UBIFS according to a second embodiment of the present invention.

FIG. 7 is a view exemplarily showing the internal structure of an EC header.

FIG. 8 is a view exemplarily showing the internal structure of a VID header.

FIG. 9 is a view exemplarily showing the structure of a configured UBI volume.

FIG. 10 is a view exemplarily showing a B+ tree structure.

FIG. 11 is a view exemplarily showing the internal structure of an i-node.

FIG. 12 is a view exemplarily showing the internal structure of a data node.

FIG. 13 is a view exemplarily showing the internal structure of a directory node.

FIG. 14 is a flowchart specifying step S220, which is a second step of recovering deleted data, in a method of recovering deleted data on a low flash memory formatted in UBIFS according to a second embodiment of the present invention.

FIG. 15 is a view exemplarily showing a directory node, an i-node, and a data node of the same file.

FIG. 16 is a flowchart specifying step S220-2 of acquiring the file name of deleted data and real data, in a method of recovering deleted data on a low flash memory formatted in UBIFS according to a second embodiment of the present invention.

### BEST MODE FOR CARRYING OUT THE INVENTION

Details of the objects and technical configurations of the present invention and operational effects according thereto will be more clearly understood by the following detailed description based on the drawings attached in the specification of the present invention. An embodiment according to the present invention will be described in detail with reference to the accompanying drawings.

The embodiments disclosed in this specification should not be construed or used as limiting the scope of the present invention. For those skilled in the art, it is natural that the description including the embodiments of the present specification have various applications. Accordingly, any embodiments described in the detailed description of the present invention are illustrative for better describing of the present invention, and are not intended to limit the scope of the present invention to the embodiments.

The functional blocks shown in the drawings and described below are merely examples of possible implementations. Other functional blocks may be used in other implementations without departing from the spirit and scope of the detailed description. In addition, although one or more functional blocks of the present invention are expressed as separate blocks, one or more of the functional blocks of the present invention may be combinations of various hardware and software configurations that perform the same function.

In addition, the expressions including certain components are expressions of “open type” and only refer to existence of corresponding components, and should not be construed as excluding additional components.

Furthermore, when a certain component is referred to as being “connected” or “coupled” to another component, it may be directly connected or coupled to another component, but it should be understood that other components may exist in between.

Hereinafter, detailed embodiments of the present invention will be described with reference to the drawings.

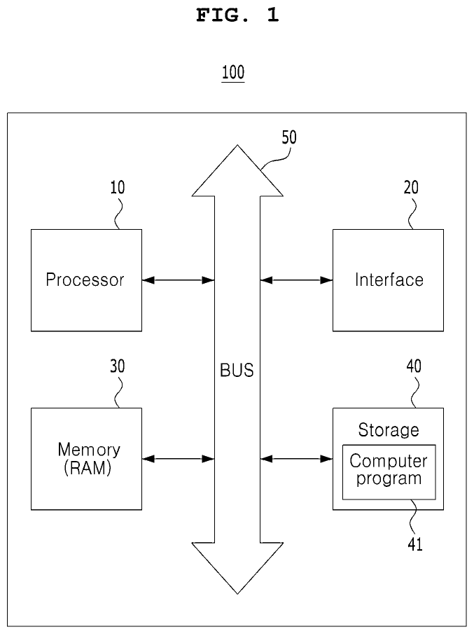

FIG. 1 is a view exemplarily showing the overall configuration of an apparatus 100 for recovering deleted data on a low flash memory formatted in UBIFS according to a first embodiment of the present invention.

However, this is only a preferred embodiment for accomplishing the objects of the present invention, and some components may be added or deleted as needed, and it goes without saying that a function performed by any one component may be performed together with another component.

An apparatus 100 for recovering deleted data on a low flash memory formatted in UBIFS according to a first embodiment of the present invention may include a processor 10, a network interface 20, a memory 30, a storage 40, and a data bus 50 connecting these components, and it goes without saying that the apparatus 100 may further include additional components required to accomplish the objects of the present invention.

The processor 10 controls the overall operation of each component. The processor 10 may be a central processing unit (CPU), a microprocessor unit (MPU), a micro controller unit (MCU), or any one of artificial intelligence processors of a type widely known in the technical field of the present invention. In addition, the processor 10 may perform operation of at least one application or program for performing a method of recovering deleted data on a low flash memory formatted in UBIFS according to a second embodiment of the present invention.

The network interface 20 supports wired and wireless Internet communication of the apparatus 100 for recovering deleted data on a low flash memory formatted in UBIFS according to a first embodiment of the present invention, and may also support other known communication methods. Accordingly, the network interface may be configured to include a communication module corresponding thereto.

The memory 30 may store various types of information, commands, and/or information, and may load one or more computer programs 41 from the storage 40 to perform a method of recovering deleted data on a low flash memory formatted in UBIFS according to a second embodiment of the present invention. Although RAM is shown as a kind of the memory 30 in FIG. 1, it goes without saying that various types of storage media may be used as the memory 30.

The storage 40 may store one or more computer programs 41 and large-capacity network information 42 in a non-temporary manner. The storage 40 may be any one among non-volatile memory such as Read Only Memory (ROM), Erasable Programmable ROM (EPROM), Electrically Erasable Programmable ROM (EEPROM), flash memory, or the like, hard disk drive (HDD), solid state drive (SSD), detachable disk, or computer-readable recording medium of an arbitrary form widely known in the technical field of the present invention.

The computer program 41 is loaded on the memory 30, and may execute, by one or more processors 10, (A) a first operation of receiving a UBI volume configured by collecting memory data from the low flash memory, and (B) a second operation of determining a node type by searching for a node header in all areas of the input UBI volume, and recovering deleted data through a structural analysis performed on each determined node type.

The operations performed by the computer program 41 briefly mentioned above may be viewed as a function of the computer program 41, and a more detailed description will be provided below in the description of a method of recovering deleted data on a low flash memory formatted in UBIFS according to a second embodiment of the present invention.

The data bus 50 functions as a moving path of instructions and/or information between the processor 10, the network interface 20, the memory 30, and the storage 40 described above.

The apparatus 100 for recovering deleted data on a low flash memory formatted in UBIFS according to a first embodiment of the present invention described above briefly may be in a form of an independent device, e.g., a form of an electronic device or a server (including cloud), and here, since the electronic device may include portable devices that are easy to carry, such as smartphones, tablet PCs, laptop PCs, PDAs, PMPs, and the like, as well as devices such as desktop PCs and server devices that are fixedly installed and used in a place, it may be any electronic device having a network function, provided that a CPU or the like corresponding to the processor 10 is installed.

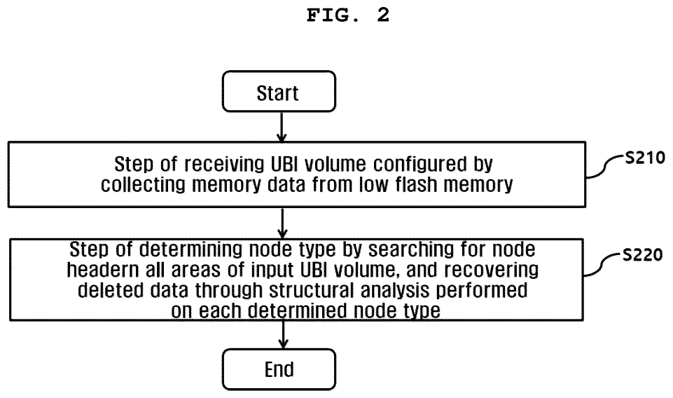

Hereinafter, a process of providing a method of recovering deleted data on a low flash memory formatted in UBIFS according to a second embodiment of the present invention through a dedicated application installed in a user terminal (not shown) of a user who desires to recover deleted data will be described with reference to FIGS. 2 to 16, on the assumption that the apparatus 100 for recovering deleted data on a low flash memory formatted in UBIFS according to a first embodiment of the present invention is in a form of a “server” among electronic devices, which are independent devices.

FIG. 2 is a flowchart illustrating representative steps of a method of recovering deleted data on a low flash memory formatted in UBIFS according to a second embodiment of the present invention.

However, this is only a preferred embodiment in accomplishing the objects of the present invention, and it goes without saying that some steps may be added or deleted as needed, and any one step may be performed to be included in another step.

Meanwhile, since it is assumed that each step is performed through the apparatus 100 for recovering deleted data on a low flash memory formatted in UBIFS according to a first embodiment of the present invention, and that the apparatus 100 for recovering deleted data on a low flash memory formatted in UBIFS according to a first embodiment of the present invention is in the form of a “server”, the dedicated application installed in the user terminal (not shown) will be viewed in the same sense as the apparatus 100 for recovering deleted data on a low flash memory formatted in UBIFS according to a first embodiment of the present invention, and all of these will be referred to as an “apparatus 100” for convenience of explanation.

In addition, although terms such as “data,” “information,” “file”, and the like will be used to be distinguished according to explanation, it is noted in advance that their actual meanings may be the same.

First, the apparatus 100 receives a UBI volume configured by collecting memory data from a low flash memory (S210), and this is referred to as a first step.

Here, the low flash memory is a memory formatted in a file system called UBIFS, and may be embedded in a specific device.

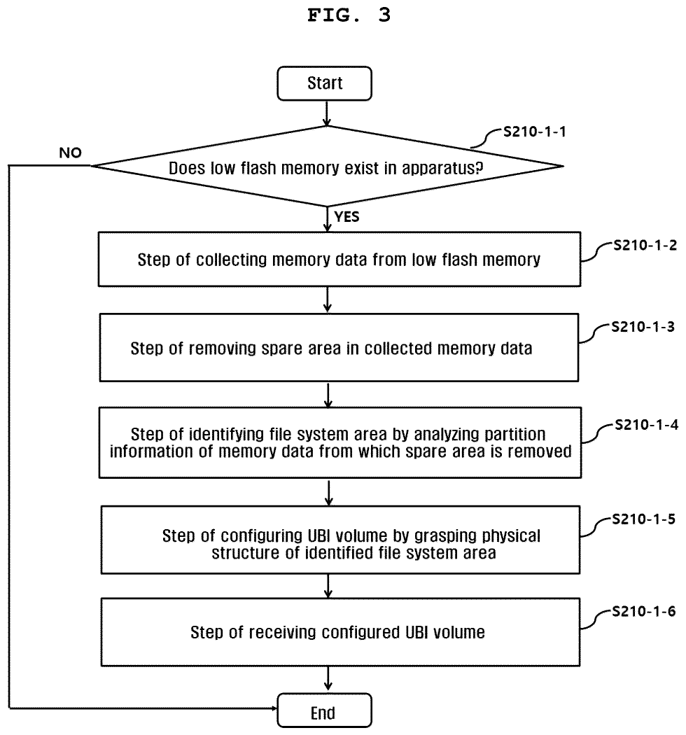

Meanwhile, the first step corresponds to a preparation step for performing digital forensics from the low flash memory, which is the target of the digital forensics, and will be described below in detail with reference to FIG. 3.

FIG. 3 is a flowchart specifying step S210, which is a first step of configuring and receiving a UBI volume, in a method of recovering deleted data on a low flash memory formatted in UBIFS according to a second embodiment of the present invention.

However, this is only a preferred embodiment in accomplishing the objects of the present invention, and it goes without saying that some steps may be added or deleted as needed, and any one step may be performed to be included in another step.

First, it is determined whether a low flash memory exists in the apparatus (S210-1-1), and this is referred to as step 1-1. When a low flash memory exists as a result of the determination, memory data is collected from the low flash memory (S210-1-1), and this is referred to as step 1-2.

Here, collection of memory data may be viewed as replication of the memory data, and the memory data may be collected from the low flash memory through a Universal Asynchronous Receiver Transmitter (UART) communication method, or the memory data may be collected through chip-off.

Thereafter, the spare area in the collected memory data is removed (S210-1-3), and this is referred to as step 1-3.

The low flash memory stores additional information on the data, stored in the memory cells, in the spare area of the memory, and more specifically, information such as Error Correction Code (ECC) or Wear leveling is stored in the spare area, and since information like this may interfere with analysis of partitions, the spare area is removed.

When the spare area has been removed, the file system area is identified by analyzing partition information of the memory data from which the spare area is removed (S210-1-4), and this is referred to as step 1-4.

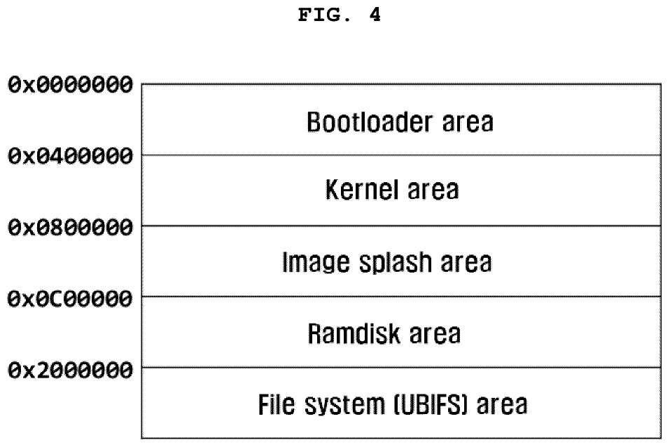

The low flash memory is divided into several partitions for each purpose, and since the method of dividing the partitions varies according to the manufacturer of the flash memory, it needs to identify the file system area by analyzing information on the partitions in the low flash memory, and FIG. 4 exemplarily shows a memory area including the file system area, from which the spare area is removed. Referring to FIG. 4, it can be confirmed that the file system area exists at the bottom, and it can be seen that the location and size of this file system area are identified at step S210-1-4.

Thereafter, the physical structure of the identified file system area is grasped to configure a UBI volume (S210-1-5), and this is referred to as step 1-5.

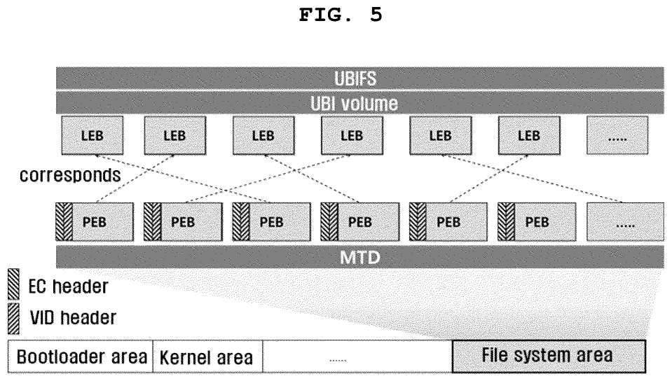

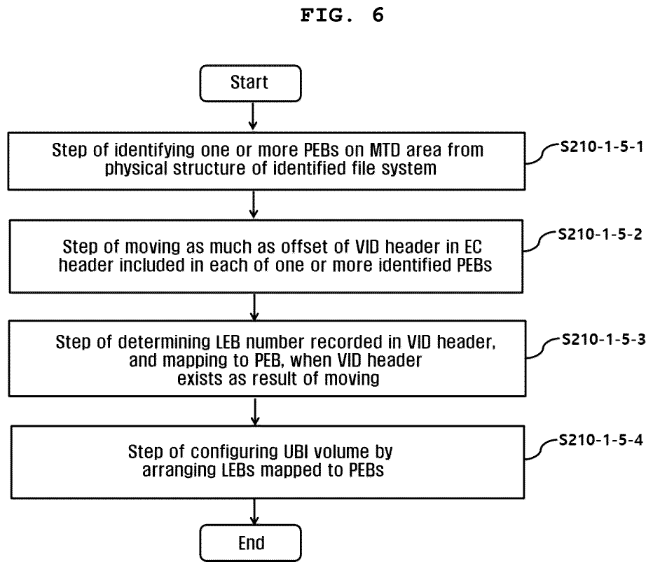

The purpose of grasping the physical structure of the file system area is to identify, from the memory data, normally stored files and deleted data, and hereinafter, a specific method of configuring the UBI volume will be described with reference to FIGS. 5 and 6.

FIG. 5 is a view exemplarily showing a mimetic diagram configuring a UBI volume, and FIG. 6 is a flowchart specifying step S210-1-5 of configuring a UBI volume, in a method of recovering deleted data on a low flash memory formatted in UBIFS according to a second embodiment of the present invention.

However, this is only a preferred embodiment in accomplishing the objects of the present invention, and it goes without saying that some steps may be added or deleted as needed, and any one step may be performed to be included in another step.

First, one or more Physical Erase Blocks (PEBs) on the Memory Technology Device (MTD) area are identified from the physical structure of the identified file system (S210-1-5-1), and this is referred to as step 1-5-1.

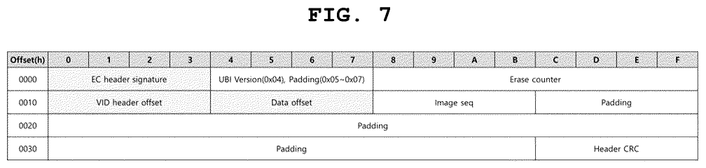

Here, the MTD area supports the flash memory so as to use the Linux kernel-based embedded OS such as UBIFS, and manages flash memory data using PEBs of 128 KB. The MTD area includes a plurality of PEBs, and referring to FIG. 5, it can be confirmed that each PEB includes an Erase Counter (EC) header, and the EC header is a header having a size of 2048 (0x800), which includes information on the location of the Volume Identifier (VID) header and the location of the data area, and its internal structure is exemplarily shown in FIG. 7.

When the PEBs are identified, the point moves as much as the offset of the Version Identifier (VID) header (S210-1-5-2) in the EC header included in each of the one or more identified PEBs, and this is referred to as step 1-5-2.

As the VID header is a header having a size of 2048 (0x800) with a Logical Erase Block (LEB) number in the UBI volume, and it is previously said that the EC header has location information of the VID header, the point moves as much as the offset of the VID header to confirm whether the VID header exists at the location indicated by the information.

Referring to FIG. 7 again, which shows the internal structure of the EC header, the location of the VID header and the data stored in a corresponding block can be confirmed in the internal structure of the EC header. The EC header structure has an EC header signature of 0x55424923 (‘UBI #’) and stores VID header offset information of 4 bytes from offset 16 (0x10). For example, when the value is 2048 (0x800), it means that the location moved as much as 2048 (0x800) bytes from the first byte of the EC header is the point where the VID header is located, and apart from this, since the EC header has data offset information of 4 bytes from offset 20 (0x14), when the value is 4096 (0x1000), it means that the location moved 4096 (0x1000) bytes from the first byte of the EC header is the area where the data is stored.

Apart from this, although it is shown in FIG. 5 that the PEB includes both the EC header and the VID header, this is an example, and it necessarily includes the EC header, but may not include the VID header.

When the VID header exists as a result of the moving, the LEB number recorded in the VID header is determined and mapped to the PEB (S210-1-5-3), and this is referred to as step 1-5-3.

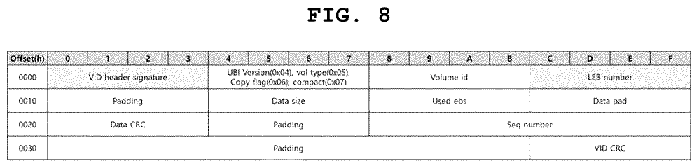

FIG. 8 is a view exemplarily showing the internal structure of a VID header. Referring to FIG. 8, the internal structure of the VID header has a VID header signature of 0x55424921 (‘UBI!’), and 4 bytes from offset 12 (0x0C) mean the location number of the LEB in the UBI volume of a corresponding block. For example, when the value is 11 (0x0B), it means that the block belongs to the 11th in the UBI volume, and through the LEB number recorded in the confirmed VID header, the LEB and the PEB having the number may be mapped.

Finally, the UBI volume is configured by arranging the LEBs mapped to the PEBs (S210-1-5-4), and this is referred to as step 1-5-4.

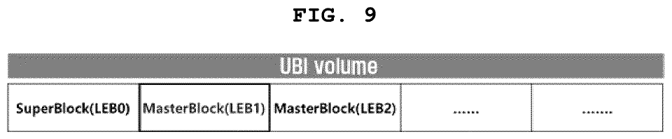

LEBs arranged to configure the UBI volume are all the LEBs mapped to the PEBs, and since each LEB has its own location number as described above, it can be understood that all the LEBs are arranged in order of their location numbers. However, this is not essential, and it will be sufficient to arrange only three LEBs including SuperBlock, i.e., the LEB of location number 0 (storing metadata of UBIFS), MasterBlock, i.e., the LEB of location number 1 (storing information on the root index node), and MasterBlock, i.e., the LEB of location number 2 (storing a copy of the LEB of location number 1) in order of the location number, and this is exemplarily shown in FIG. 9.

Now, FIG. 3 will be described again.

When a UBI volume is configured, the configured UBI volume is input (S210-1-6), and this is referred to as step 1-6.

Here, “input” of the UBI volume has a meaning of “loading” when the apparatus 100 itself configures the UBI volume and has a meaning of “receiving” when it performs a function of receiving a UBI volume configured by another apparatus, and it may be regarded that either case corresponds to step S210-1-6.

So far, the process of configuring and inputting a UBI volume has been described with reference to FIGS. 3 to 9. Hereinafter, before describing the step of recovering deleted data with reference to FIG. 2 again, the B+ tree structure used for storing data in the UBIFS and the nodes that configure the B+ tree structure will be described first.

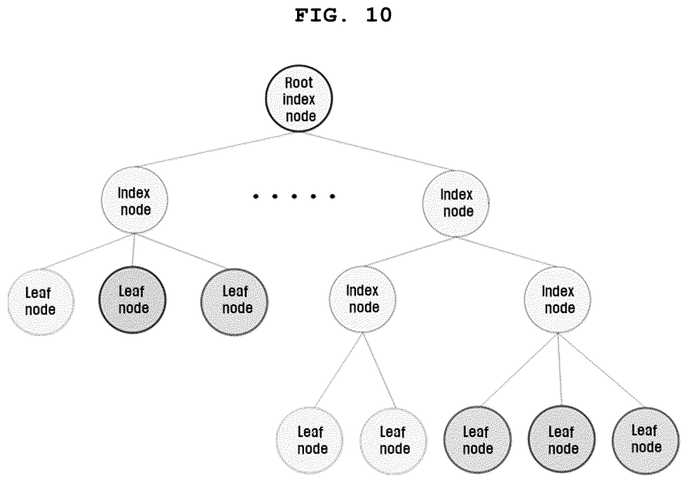

FIG. 10 is a view exemplarily showing a B+ tree structure. Referring to FIG. 10, it is named as a tree structure since the view of connecting nodes under the node at the top and connecting other nodes under the connected nodes looks like a tree, and the node at the top is referred to as the root index node, the nodes under the root index node are referred to as index nodes, and the nodes at the bottom are referred to as leaf nodes.

Since the B+ tree structure stores all the data in the leaf nodes at the bottom, and stores location information for locating a leaf node in the index nodes, the index node stores an address (pointer) pointing the next node, and when searching for a specific data, a leaf node that stores the data can be found through the address pointed by each index node, and this has an advantage of efficiently storing and searching for a large amount of data.

Meanwhile, leaf nodes that actually store data in the B+ tree structure possess information on files and directories, and each file and directory have three types of nodes including an i-node having a node type value of 0, a data node having a node type value of 1, and a directory node having a node type value of 2.

Here, since the i-node stores meta information, such as the location of the data node, file creation and modification dates, and the like, and the data node stores actual file data, the stored data can be acquired through the information on the location and length of data, and the directory node stores information on the file name.

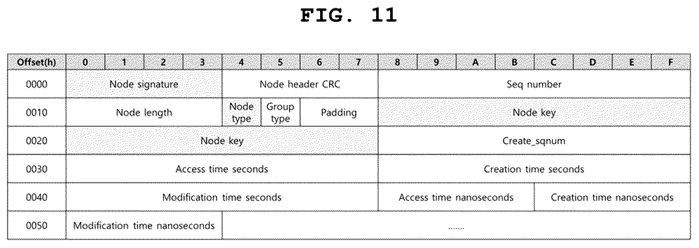

FIGS. 11 to 13 are views exemplarily showing the internal structures of the i-node, data node, and directory node, respectively. Referring to FIG. 11, the i-node has a common node header from the first byte to offset 23 (0x17), and at this point, when the node type value at offset 20 (0x14) is 0 (0x00), it means an i-node. Next 16 bytes from offset 24 (0x18) store the key value of the node (Node key), and the upper 4 bytes of the node key are needed to grasp the relations and locations of the data node and the i-node related to the node.

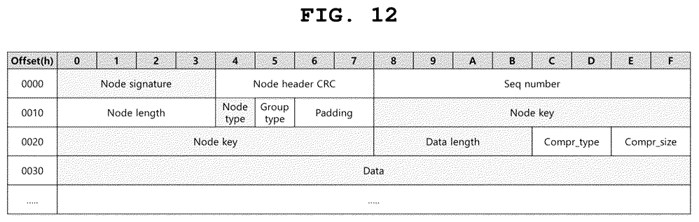

Referring to FIG. 12, like the i-node, the data node has a common node header structure from the first byte to offset 23 (0x17), and the node type value at offset 20 (0x14) is 1 (0x01). 16 bytes from offset 24 (0x18) mean the node key, and upper 4 bytes of the 16-byte of the key value are the same as the upper 4 bytes of Inum, which is the key value of the i-node, and used to grasp the locations of the directory node and the i-node. 4 bytes from 40 (0x28) mean the data length, and actual data as much as the data length may be stored from offset 50 (0x32).

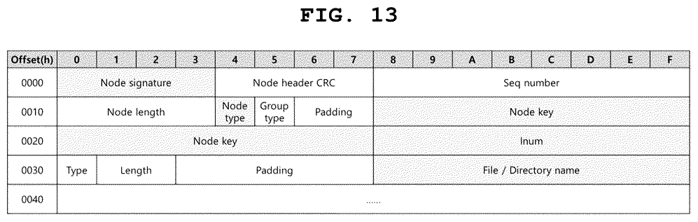

Referring to FIG. 13, like the i-node and the data node, the directory node has a common node header structure from the first byte to offset 23 (0x17), and the node type value at offset 20 (0x14) is 2 (0x02). 16 bytes from offset 0x18 store the key value (Node key) of the directory node, and upper 4 bytes of the value mean the Inum value of the upper directory. 8 bytes from offset 0x28 store the value of Inum (I-node Number). Since the upper 4 bytes, i.e., Inum, of the directory node, the upper 4 bytes of the node key of the i-node, and the upper 4 bytes of the node key of the data node have the same value for the same file and directory, it is possible to distinguish the data node and the i-node related to the directory node itself through the Inum value. Next, offset 56 (0x38) means the file name or directory name (File/Directory name) of the data.

The method of recovering deleted data on a low flash memory formatted in UBIFS according to a second embodiment of the present invention may recover deleted data using the B+ tree structure described above and the characteristics of the i-node, data node, and directory node, and this is about the second step. This will be described with reference to FIG. 2 again.

When a UBI volume is input, the apparatus 100 searches for the node header in all areas of the input UBI volume to determine a node type, and recovers deleted data through a structural analysis performed on each determined node type (S22), and this is referred to as the second step.

Here, the node type determined by the apparatus 100 may be either a directory node or a data node, which are leaf nodes according to the B+ tree structure, and the reasons of not including the i-node described above will be described below.

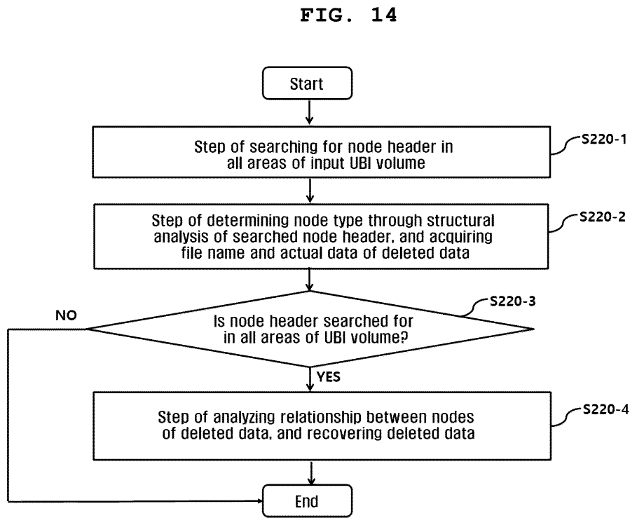

FIG. 14 is a flowchart specifying step S220, which is a second step of recovering deleted data, in a method of recovering deleted data on a low flash memory formatted in UBIFS according to a second embodiment of the present invention.

However, this is only a preferred embodiment in accomplishing the objects of the present invention, and it goes without saying that some steps may be added or deleted as needed, and any one step may be performed to be included in another step.

First, the node header is searched for in all areas of the input UBI volume (S220-1), and this is referred to as step 2-1.

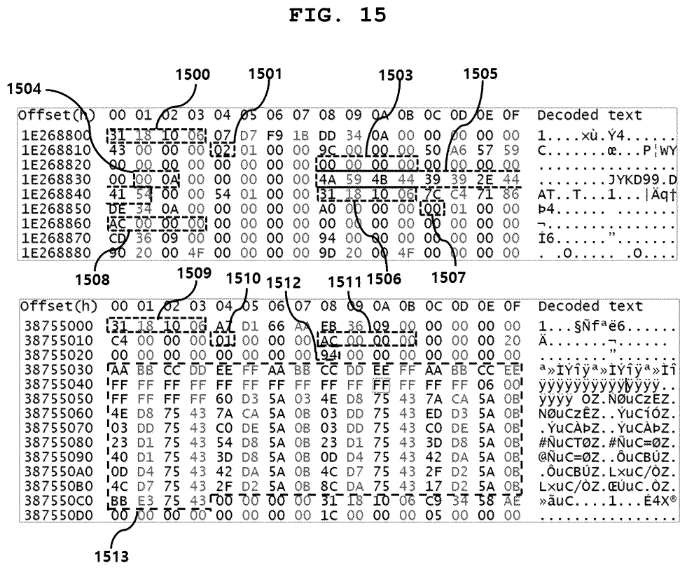

FIG. 15 is a view exemplarily showing a directory node, an i-node, and a data node of the same file. Referring to FIG. 15, searching for a node header at step S220-1 may be searching for 0x31181006 (1500), which is the unique value of the node header, in all areas of the UBI volume.

When the node header is searched, a node type is determined through a structural analysis of the searched node header, and the file name and actual data of the deleted data are acquired (S220-2), and this is referred to as step 2-2.

As it is described above that a node type can be determined for each node through a structural analysis of the node header, more specifically, through the node type value, node type values of 0 (0x00), 1 (0x01), and 2 (0x02) may indicate the i-node, the data node, or the directory node, respectively.

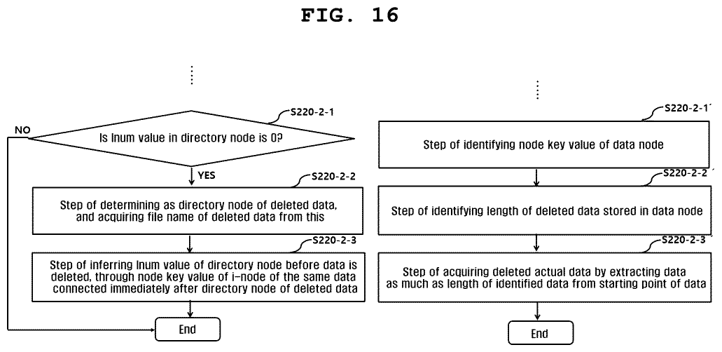

The apparatus 100 may perform individual processes to acquire the file name and actual data of the deleted data when the determined node type is a directory node or a data node, and this will be described below with reference to FIG. 16.

FIG. 16 is a flowchart specifying step S220-2 of acquiring the file name of deleted data and real data, in a method of recovering deleted data on a low flash memory formatted in UBIFS according to a second embodiment of the present invention.

However, this is only a preferred embodiment in accomplishing the objects of the present invention, and it goes without saying that some steps may be added or deleted as needed, and any one step may be performed to be included in another step.

When the determined node type is a directory node, it is determined whether the Inum value in the directory node is 0 (S220-2-1), and this is referred to as step 2-2-1.

As the Inum value of the directory node shows a specific value before the data is deleted and changes to 0 after the data is deleted, it is determined whether the Inum value in the directory node is 0 to confirm whether it is a directory node of the deleted data.

When the Inum value is 0 as a result of the determination, the node type is determined as the directory node of the deleted data, and the file name of the deleted data is acquired from the directory node (S220-2-2), and this is referred to as step 2-2-2.

Describing this with reference to FIG. 15, since the node having a node type value of 2 (1501) is a directory node in FIG. 15, the node existing at offset 0x1E268800 is a directory node, and it is confirmed above that the node header unique value of the directory node is 0x31181006 (1500).

Meanwhile, since it can be confirmed that the Inum value of the directory node is 0x00000000 (1503), the directory node may be defined as the directory node of the deleted data, and as the directory node stores the file name, the file name (1505) as long as the length (1504) of the file name may be acquired and stored.

Thereafter, the Inum value of the directory node before the data is deleted is inferred through the node key value of the i-node for the same data connected immediately after the directory node of the deleted data (S220-2-3), and this is referred to as step 2-2-3.

The node type determined by the apparatus 100 is either a directory node or a data node, which are leaf nodes according to the B+ tree structure, and describing the reasons of not including the i-node is postponed, and since the i-node of the same data is connected immediately after the directory node without fail, the i-node is not included in the searched and determined node type. That is, when a directory node is determined, details of the i-node can be confirmed naturally.

Describing this with reference to FIG. 15, the node existing at offset 0x1E268848, which is connected immediately after the directory node, is an i-node, of which the unique value of the node header is 0x31181006 (1506) and the node type value is 0 (1507).

As it can be confirmed that the node key value of the i-node is 0xAC000000 (1508), it can be inferred that 0x00000000 (1503), which is the current Inum value of the directory node for the same deleted data, is 0xAC000000 before the data is deleted.

Meanwhile, when the determined node type is a data node, the node key value of the data node is identified (S220-2-1′), and this is referred to as step 2-2-1′.

Describing this with reference to FIG. 15, the node existing at offset 0x38755000 is a data node, of which the unique value of the node header is 0x31181006 (1509), and the node type value is 1 (1510).

It can be confirmed that the node key value of the data node is 0xAC000000 (1511).

Thereafter, the length of the deleted data stored in the data node is identified (S220-2-2′), and this is referred to as step 2-2-2′, and then, the deleted actual data is acquired by extracting data as much as the identified length of data from the starting point of the data (S220-2-3′), and this is referred to as step 2-2-3′.

Describing this with reference to FIG. 15, the length (1512) of the deleted data is identified, and the actual data (1513) may be acquired as much as the identified length from offset 0x38755030, which is the starting point of the data.

Now, FIG. 14 will be described again.

When the file name and actual data of the deleted data are acquired, it is determined whether all node headers are searched in all areas of the input UBI volume (S220-2-3), and this is referred to as step 2-3, and when all node headers are searched as a result of the determination, the relationship between the nodes of the deleted data is analyzed, and the deleted data is recovered (S220-2-4), and this is referred to as step 2-4.

Here, as it has been described above that an i-node, a directory node, and a data node exist for the same data, analyzing the relationship between the nodes of the deleted data is analyzing a directory node of the deleted data and a data node having a node key value the same as the Inum value, which is inferred through the node key value of the i-node of the same data connected to the directory node of the deleted data, as the directory node and the data node of the same data.

Describing this with reference to FIG. 15, it is inferred that the Inum value before the data of the directory node is deleted is 0xAC000000 as the node key value of the i-node is 0xAC000000 (1508), and since the node key value of the identified data node is 0xAC000000 (1511) the same as the Inum value, the directory node and the data node are analyzed as the directory node and the data node of the same deleted data.

Furthermore, the file name is acquired through the directory node and the actual data is acquired through the data node, and since the two nodes are analyzed as nodes of the same deleted data, the acquired file name and actual data may be recovered as the file name and actual data of the deleted data.

Until now, a method of recovering deleted data on a low flash memory formatted in UBIFS according to a second embodiment of the present invention has been described. According to the present invention, as deleted data existing in an unallocated area of UBIFS can be recovered using the B+ tree structure and the characteristics of nodes, digital forensic analysis of the UBIFS can be performed more easily.

Finally, since the apparatus 100 for recovering deleted data on a low flash memory formatted in UBIFS according to a first embodiment of the present invention and the method of recovering deleted data on a low flash memory formatted in UBIFS according to a second embodiment of the present invention may also be implemented as a computer program stored in a computer-readable medium according to a third embodiment of the present invention, in this case, (AA) a first step of receiving a UBI volume configured by collecting memory data from the low flash memory, and (BB) a second step of determining a node type by searching for a node header in all areas of the input UBI volume, and recovering deleted data through a structural analysis performed on each determined node type may be executed in combination with a computing device, and although it is not described in detail for duplicated description, it goes without saying that all technical features applied to the apparatus 100 for recovering deleted data on a low flash memory formatted in UBIFS according to a first embodiment of the present invention and the method of recovering deleted data on a low flash memory formatted in UBIFS according to a second embodiment of the present invention may be equally applied to the computer program stored in a computer-readable medium according to a third embodiment of the present invention.

Although the embodiments of the present invention have been described above with reference to the accompanying drawings, those skilled in the art will understand that the present invention can be implemented in other specific forms without changing its technical spirit or essential features. Therefore, the embodiments described above should be understood in all respects as illustrative and not restrictive.

### DESCRIPTION OF SYMBOLS

10: Processor
20: Network interface
30: Memory
40: Storage
41: Computer program
50: Information Bus
100: Apparatus for recovering deleted data on low flash memory formatted in UBIFS

1. A method of recovering deleted data on a low flash memory formatted in Unsorted Block Image File System (UBIFS) by an apparatus including a processor and a memory, the method comprising:
(a) a first step of receiving a UBI volume configured by collecting memory data from the low flash memory; and
(b) a second step of determining a node type by searching for a node header in all areas of the input UBI volume, and recovering deleted data through a structural analysis performed on each determined node type, wherein
the determined node type is either a directory node or a data node, which are leaf nodes according to a B+ tree structure.

2. The method according to claim 1, wherein the first step includes any one or more among:
step 1-1 of determining whether the low flash memory exists in the apparatus;
step 1-2 of collecting, when a low flash memory exists as a result of the determination, memory data from the low flash memory;
step 1-3 of removing a spare area in the collected memory data;
step 1-4 of identifying a file system area by analyzing partition information of the memory data from which the spare area is removed;
step 1-5 of configuring the UBI volume by grasping a physical structure of the identified file system area; and
step 1-6 of receiving the configured UBI volume.

3. The method according to claim 2, wherein collection of memory data at step 1-2 is collection of memory data from the low flash memory through a Universal Asynchronous Receiver Transmitter (UART) communication method.

4. The method according to claim 2, wherein step 1-5 includes any one or more among:
step 1-5-1 of identifying one or more Physical Erase Blocks (PEBs) on a Memory Technology Device (MTD) area from the physical structure of the identified file system area;
step 1-5-2 of moving as much as an offset of a Version Identifier (VID) header in an EC header included in each of the one or more identified PEBs;
step 1-5-3 of determining, when a VID header exists as a result of the moving, a Logical Erase Block (LEB) number recorded in the VID header, and mapping the LEB number to the PEB; and
step 1-5-4 of configuring the UBI volume by arranging LEBs mapped to the PEBs.

5. The method according to claim 1, wherein the second step includes any one or more among:
step 2-1 of searching for a node header in all areas of the input UBI volume;
step 2-2 of determining a node type through a structural analysis of the searched node header, and acquiring a file name and actual data of the deleted data;
step 2-3 of determining whether all node headers are searched in all areas of the input UBI volume; and
step 2-4 of analyzing a relationship between nodes of the deleted data and recovering the deleted data when all node headers are searched as a result of the determination.

6. The method according to claim 5, wherein searching for a node header at step 2-1 is searching for 0x31181006 (1500), which is a unique value of the node header, in all areas of the UBI volume.

7. The method according to claim 5, wherein when the node type determined at step 2-2 is a directory node, step 2-2 includes any one or more among:
step 2-2-1 of determining whether an Inum value in the directory node is 0;
step 2-2-2 of determining the node type, when the Inum value is 0 as a result of the determination, as the directory node of the deleted data, and acquiring a file name of the deleted data from the directory node; and
step 2-2-3 of inferring an Inum value of the directory node before the data is deleted through a node key value of an i-node of the same data connected immediately after the directory node of the deleted data.

8. The method according to claim 5, wherein when the node type determined at step 2-2 is a data node, step 2-2 includes any one or more among:
step 2-2-1′ of identifying a node key value of the data node;
step 2-2-2′ of identifying a length of the deleted data stored in the data node; and
step 2-2-3′ of acquiring deleted actual data by extracting data as much as the identified length of data from a starting point of the data.

9. The method according to claim 5, wherein analyzing a relationship between nodes of the deleted data at step 2-4 is analyzing a directory node of the deleted data and a data node having a node key value the same as the Inum value, which is inferred through the node key value of the i-node of the same data connected to the directory node of the deleted data, as a directory node and a data node of the same data.

10. An apparatus for recovering deleted data on a low flash memory formatted in UBIFS, the apparatus comprising:
one or more processors;
a network interface;
a memory for loading a computer program executed by the processors; and
a storage for storing large-capacity network data and the computer programs, wherein
the computer program executes (A) a first operation of receiving a UBI volume configured by collecting memory data from the low flash memory; and (B) a second operation of determining a node type by searching for a node header in all areas of the input UBI volume, and recovering deleted data through a structural analysis performed on each determined node type, by the one or more processors, wherein
the determined node type is either a directory node or a data node, which are leaf nodes according to a B+ tree structure.

11. A computer program stored in a computer-readable medium, the program comprising:
(AA) a first step of receiving a UBI volume configured by collecting memory data from a low flash memory; and
(BB) a second step of determining a node type by searching for a node header in all areas of the input UBI volume, and recovering deleted data through a structural analysis performed on each determined node type, in combination with a computing device, wherein
the determined node type is either a directory node or a data node, which are leaf nodes according to a B+ tree structure.
